(19) United States
(12) Patent Application Publication
(10) Pub. No.: US 2026/0141164 A1
(43) Pub. Date: May 21, 2026

(54) AUTOMATIC LAYOUT GENERATION

(71) Applicant: Adobe Inc., San Jose, CA (US)

(72) Inventors: Wanrong Zhu, Lynwood, WA (US); Ruiyi Zhang, San Jose, CA (US); Jennifer Anne Healey, San Jose, CA (US)

(73) Assignee: Adobe Inc., San Jose, CA (US)

(21) Appl. No.: 18/951,324

(22) Filed: Nov. 18, 2024

(51) Int. Cl. G06F 40/106; G06T 3/40

(52) U.S. Cl. CPC G06F 40/106; G06T 3/40; G06T 2200/24

(57) ABSTRACT

Automatic layout generation is described. In one or more examples, an input including one or more visual elements, an indication of a type of a document for generation, and a size of the document are received. Based on the type of the document and the size of the document, a layout for the one or more visual elements on the document is determined using a machine learning model. One or more coordinates of one or more bounding boxes, respectively, are determined for placement of the one or more visual elements in the layout on the document using the machine learning model. The document is then generated by incorporating the one or more visual elements into the one or more bounding boxes in the layout for presentation in a user interface.

### BACKGROUND

In graphic design, documents are electronically generated representations of visual information and are used for a variety of applications, including advertising, education, and entertainment. Examples of documents include posters, banners, pamphlets, brochures, postcards, book covers, business cards, stationery, or other two-dimensional media. Documents typically include multiple visual elements, including images, text and graphics, arranged in a layout. Layouts aid in organizing information in a useful manner on a document and help convey a cohesive message using the visual elements. However, generating documents is time-consuming and results in visual inaccuracies, computational inefficiencies, and increased power consumption in real world scenarios.

### SUMMARY

Automatic layout generation is described. In one or more examples, a layout system receives an input including one or more visual elements, an indication of a type of a document for generation, and a size of the document. In some examples, the input additionally includes a textual description of the document. For example, the indication of the type of the document describes an intended use for the document.

Based on the type of the document and the size of the document, the layout system determines a layout for the one or more visual elements on the document using a machine learning model. The machine learning model, for instance, is a multimodal large language model (MLLM) trained on multimodal document layouts and textual instructions for layout generation.

The layout system determines one or more coordinates of one or more bounding boxes, respectively, for placement of the one or more visual elements in the layout on the document using the machine learning model. The layout system then generates the document by incorporating the one or more visual elements into the one or more bounding boxes in the layout for presentation in a user interface. In some examples, the layout system scales the one or more visual elements to fit the one or more bounding boxes. Additionally, in some examples the one or more visual elements includes at least one of images or text, and the layout system converts the text to an image depicting the text for incorporation into the one or more bounding boxes.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for automatic layout generation as described herein.

FIG. 2 depicts a system in an example implementation showing operation of a layout module for automatic layout generation.

FIG. 3 depicts an example of an input for automatic layout generation.

FIG. 4 depicts an example of determining a layout and determining coordinates of bounding boxes.

FIG. 5 depicts an example of generating a document by incorporating visual elements into the bounding boxes.

FIG. 6 depicts a procedure in an example implementation of automatic layout generation.

FIG. 7 depicts a procedure in an additional example implementation of automatic layout generation.

FIG. 8 depicts an example of a method for training a machine learning model according to aspects of automatic layout generation.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Documents include digital or printed compositions of visual elements used for a variety of applications, including advertising, education, and entertainment. Different layouts are used for organizing the visual elements on different types of documents to effectively convey information to a viewer. For instance, posters and fliers include images and text organized in different layouts. Conventional layout systems allow selection of layouts from pre-made templates. However, the pre-made templates are offered with a “one size fits all” approach and are generally not available in multiple sizes for different types of documents, which limits the ability to generate documents with specific dimensions. For instance, a poster template is available for an 8.5″×11″ poster, but not for other sizes. Some systems allow customization of the pre-made templates, but this involves tedious manual manipulation of specific information, including changing visual element sizes, locations, background selections, and other metrics.

To address these limitations, a trained machine learning model is leveraged to generate a layout for visual elements based on an intended type of document described by a text-based user input. By accommodating text-based user inputs, for example, “Create a 10″×14″ book cover with the attached images and text,” automatic layout generation reduces the number of inputs compared to manual manipulation of the pre-made templates offered by conventional layout systems.

A layout system begins in this example by receiving an input including visual elements, an indication of a document type, and an indication of a document size. The visual elements include one or more varieties of digital media, including photographs, vector graphics, raster graphics, or text for incorporation onto the document. The document type indicates a type of composition of media to be created involving an arrangement of the visual elements onto the document. Examples of the document type include a book cover, a flyer, a pamphlet, a poster, a business card, a report cover, a postcard, a banner, a magazine page, or other type of digital media or print media. The document size indicates a size of the document that is intended to be created. In this example, the document type and the document size are received in as part of the text-based prompt describing the desired document to be created.

The layout system uses a machine learning model to determine a layout based on the document type and the document size. The layout is a specific arrangement for the visual elements on the document to be created. The machine learning model is a multimodal large language model (MLLM) trained on training data including layouts corresponding to multiple visual element inputs and instructions indicating document types and sizes. For example, a layout is different for a book cover than for a brochure, and the machine learning model is capable of determining appropriate layouts depending on the document type. Additionally, layouts are different for different document sizes. For instance, the layout for a 12″×16″ coffee table book cover is different from a 10″×8″ children's book cover. The machine learning model therefore is trained to determine a layout that includes an aesthetically-pleasing arrangement of the visual elements on the document based on the document type and/or the document size.

The layout system then generates bounding boxes indicating placement positions of the visual elements in the layout on the document. For instance, the bounding boxes are rectangles or masks that designate specific positions for placement of the visual elements on the document. The bounding boxes have coordinates indicating locations of corners of the bounding boxes relative to dimensions of the document. One bounding box, for instance, corresponds to placement of a specific image from the visual elements, while a second bounding box corresponds to placement of a specific piece of text from the visual elements.

To generate the document, the layout system positions the visual elements in the corresponding bounding boxes on the document. In some examples, this involves cropping or adjusting the visual elements to fit the bounding boxes. After placement of the visual elements on the document, the layout system accommodates further editing of the document to allow additional customization.

Automatic layout generation in this manner addresses the limitations of conventional layout systems that are limited to applying visual elements to pre-made templates. For example, employing a machine learning model to determine a layout for the visual elements based on an input specifying a type of a document and a size of the document allows the layout system to determine an aesthetically-pleasing composition for the visual elements based on an intended use for the document. Further, automatic layout generation reduces the number of inputs compared to manual manipulation of the pre-made templates offered by conventional layout systems.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

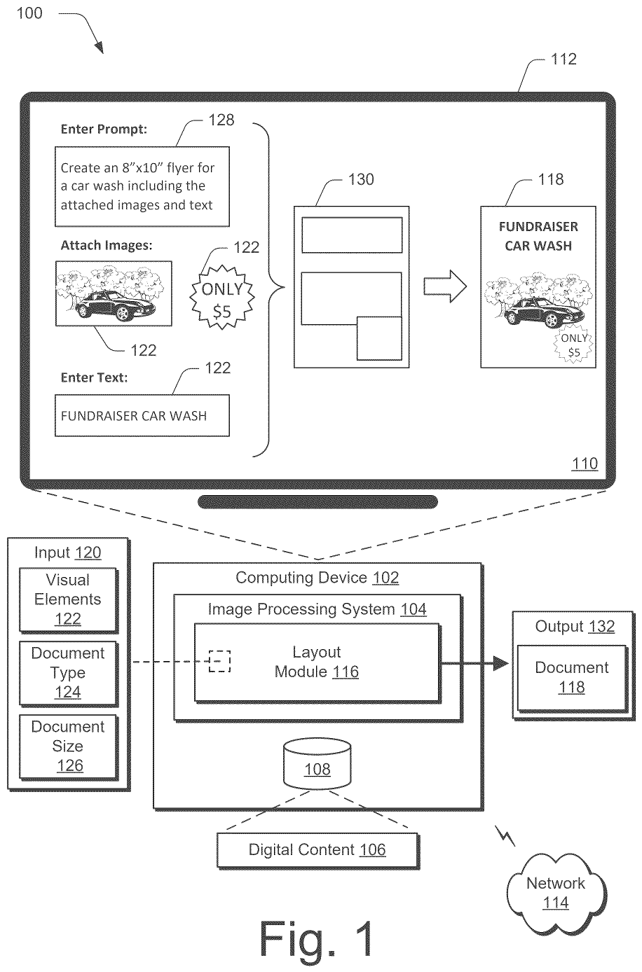

FIG. 1 is an illustration of a digital medium environment 100 in an example implementation that is operable to employ techniques and systems for automatic layout generation described herein. The illustrated digital medium environment 100 includes a computing device 102, which is configurable in a variety of ways.

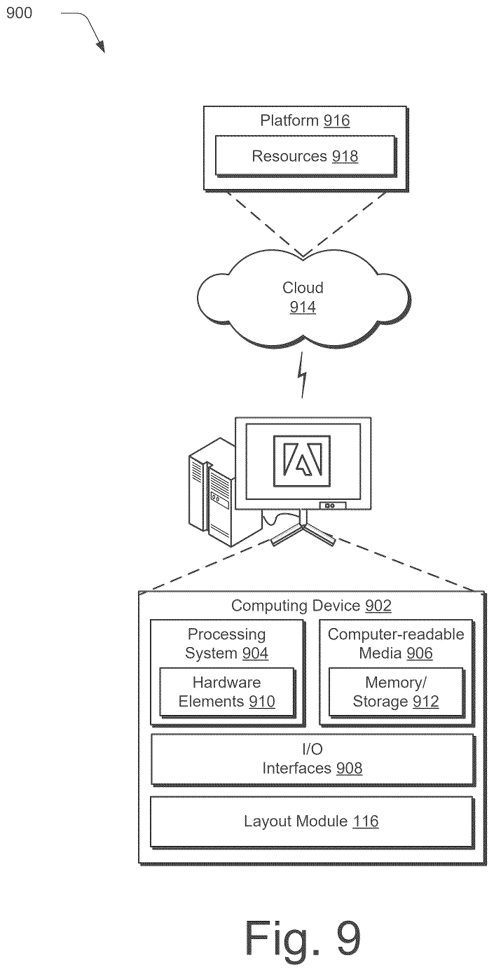

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 9.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a layout module 116 which is illustrated as incorporated by the image processing system 104 to process the digital content 106. In some examples, the layout module 116 is separate from the image processing system 104 such as in an example in which the layout module 116 is available via the network 114.

The layout module 116 is configured to generate a document 118 that includes an arrangement of media. For instance, the layout module 116 receives an input 120 including visual elements 122, a document type 124, and/or a document size 126. The visual elements 122 include one or more of digital images, vector graphics, raster graphics, or text. In some examples, the visual elements 122 are selected from a menu displayed in a user interface or are uploaded from storage. The document type 124 indicates a type of composition of media to be created involving an arrangement of the visual elements 122. Examples of the document type 124 include a book cover, a flyer, a pamphlet, a poster, a business card, a report cover, a postcard, a banner, magazine page, or other type of digital media or print media. The document size 126 indicates a size in units of the document 118 to be created.

In some examples, the layout module 116 obtains the document type 124 and/or the document size 126 from a prompt 128. For instance, the prompt 128 specifies “Create an 8″×10″ flyer for a car wash including the attached images and text.” In this example, the document type 124 is a flyer, and the document size 126 is 8″×10″.

The layout module 116 leverages a machine learning model to determine a layout 130 for the visual elements 122 based on the document type 124 and/or the document size 126. The machine learning model is a multimodal large language model (MLLM) trained on text indicating layouts corresponding to multiple inputs indicating document types and sizes and is capable of comprehending detailed visual element inputs. For example, different layouts are used for vertical documents, including posters, than for horizontal documents, including banners. The layout module 116 therefore uses the machine learning model to determine an aesthetically-pleasing layout corresponding to given parameters based on the document type 124 and the document size 126. In some examples, the layout 130 includes bounding boxes indicating positions for the visual elements 122 in the layout 130. Positions of the bounding boxes are determined by the machine learning model. The visual elements 122, for instance, are positioned based on coordinates of the bounding boxes.

The layout module 116 then generates an output 132 including the document 118 by incorporating the visual elements 122 into the bounding boxes indicated in the layout 130. In some examples, for instance, the visual elements 122 are cropped to fit the bounding boxes of the layout 130. In examples involving visual elements 122 that include text, the text is converted to an image of the text for incorporation into the bounding boxes to preserve font styles, font sizes, or other attributes of the text during placement. Additionally, in some examples the layout module 116 selects backgrounds or other visual properties for the document 118 based on the document type 124 using the machine learning model.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

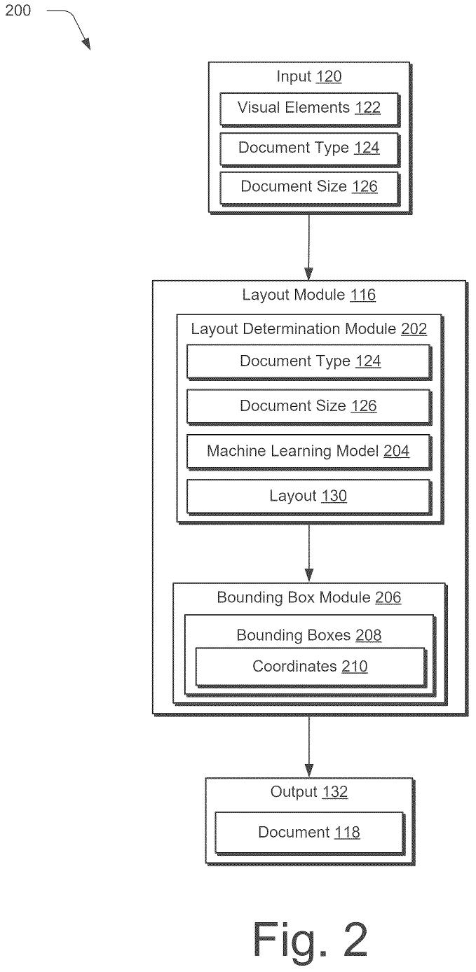

FIG. 2 depicts a system 200 in an example implementation showing operation of the layout module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-9.

To begin in this example, a layout module 116 receives an input 120 including visual elements 122, an indication of a document type 124, and/or an indication of a document size 126. The visual elements 122 include one or more varieties of digital media, including images, vector graphics, raster graphics, or text. The document type 124 indicates a type of composition of media to be created involving an arrangement of the visual elements 122 on a document 118. Examples of the document type 124 include a book cover, a flyer, a pamphlet, a poster, a business card, a report cover, a postcard, a banner, magazine page, or other type of digital media or print media. The document size 126 indicates a size of the document 118 that is intended to be created, for example, a 9″×11″ magazine cover.

The layout module 116 includes a layout determination module 202. The layout determination module 202 leverages a machine learning model 204 to determine a layout 130 based on the document type 124 and/or the document size 126. The layout 130 is a specific arrangement for the visual elements 122 or types of the visual elements 122 on the document 118 to be created. The machine learning model 204 is a multimodal large language model (MLLM) trained on training data including layouts corresponding to multiple inputs indicating document types and sizes. For example, the layout 130 is different for a book cover than for a business card, and the machine learning model 204 is trained to determine the layout 130 based on whether the document type 124 is a book cover or a business card. Additionally, the layout 130 is different for different document sizes. For instance, the layout 130 for a 12″×16″ coffee table book is different from a 10″×8″ children's book. The machine learning model 204 therefore is trained to determine the layout 130 that includes an aesthetically-pleasing arrangement of the visual elements 122 on the document 118 based on the document type 124 and/or the document size 126.

The layout module 116 also includes a bounding box module 206. The bounding box module 206 generates bounding boxes 208 indicating placement positions of the visual elements 122 in the layout 130 for the document 118. For instance, the bounding boxes 208 are rectangles or masks that designate specific positions for placement of the visual elements 122 on the document 118. The bounding boxes 208, for instance, have coordinates 210 indicating location of corners of the bounding boxes 208 relative to dimensions of the document 118. One bounding box, for instance, corresponds to placement of a specific image from the visual elements 122, while a second bounding box corresponds to placement of a specific piece of text from the visual elements 122.

After positioning the visual elements 122 in the bounding boxes 208 of the layout 130 to generate the document 118, the layout module 116 generates an output 132 including the document 118 for display in a user interface 110. To do this, the layout module 116 positions the visual elements 122 in the corresponding bounding boxes 208 on the document 118. In some examples, this involves cropping or adjusting the visual elements 122 to fit the bounding boxes 208.

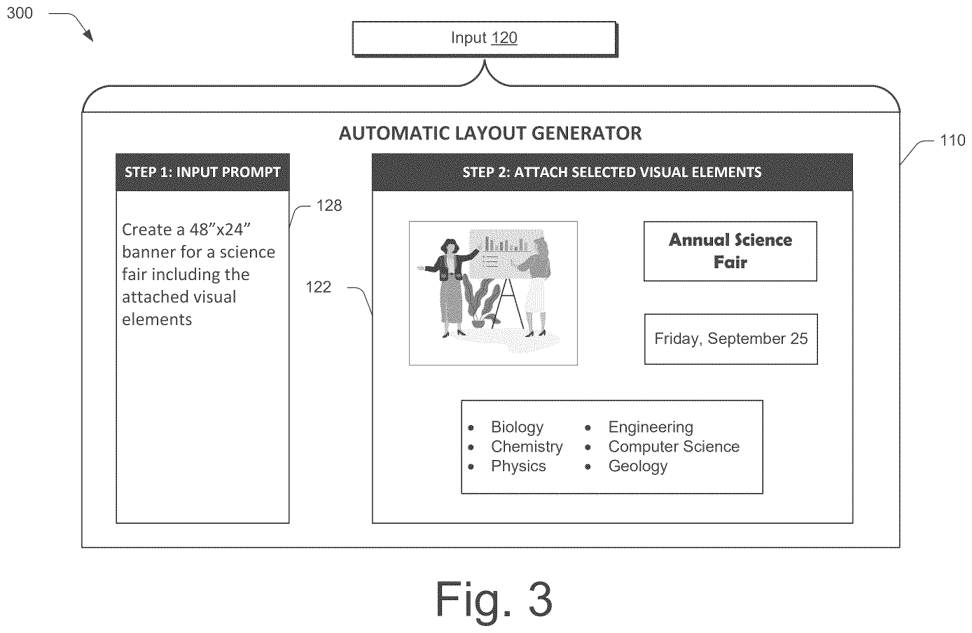

FIGS. 3-5 depict stages of automatic layout generation. In some examples, the stages depicted in these figures are performed in a different order than described below.

FIG. 3 depicts an example 300 of an input for automatic layout generation. As illustrated, the layout module 116 receives an input 120 including visual elements 122, an indication of a document type 124, and/or an indication of a document size 126. The document type 124 indicates a type of composition of media to be created involving an arrangement of the visual elements 122 on a document 118. Examples of the document type 124 include a book cover, a flyer, a pamphlet, a poster, a business card, a report cover, a postcard, a banner, magazine page, or other type of digital media or print media. The document size 126 indicates a size of the document 118 that is intended to be created, for example, given measurements for a width and height of the document 118. The width and the height of the document 118, for instance, is measured in customary units, metric units, pixels, or other measurement conventions.

In this example, the document type 124 and the document size 126 are extracted from a prompt 128. For instance, the prompt 128 reads “Create a 48″×24″ banner for a science fair including the attached visual elements.” Therefore, the prompt 128 indicates that the document type 124 is a banner, and the document size 126 is 48″×24″. In some examples, the layout module 116 leverages a multimodal large language model (MLLM) that is trained to determine the document type 124 and/or the document size 126 from text inputs. For instance, the MLLM is trained on training data including prompts and accompanying document types and document sizes indicated by the prompts.

In this example, the prompt 128 is accompanied by a selection of visual elements 122, which are selected from storage for inclusion on the document 118. The visual elements 122 include one or more varieties of digital media, including images, vector graphics, raster graphics, or text. As illustrated, the visual elements 122 in this example include an image of a science fair, text for a title “Annual Science Fair,” text for a subtitle “Friday, September 25,” and a bulleted list of text including “Biology, Chemistry, Physics, Engineering, Computer Science, and Geology,” which are intended for inclusion on the document 118, which is a banner to advertise a science fair. In this example, however, the input 120 does not provide instructions for where to place the visual elements 122 on the document 118 other than indicating the document type 124 and the document size 126 in the prompt 128.

In some examples, the input 120 further includes designations of a layered order for the visual elements 122. For examples, the layout module 116 receives an indication that a visual element is a “background,” a “featured image,” “text,” an “overlay,” or other designation relating the order of the visual elements to the other visual elements.

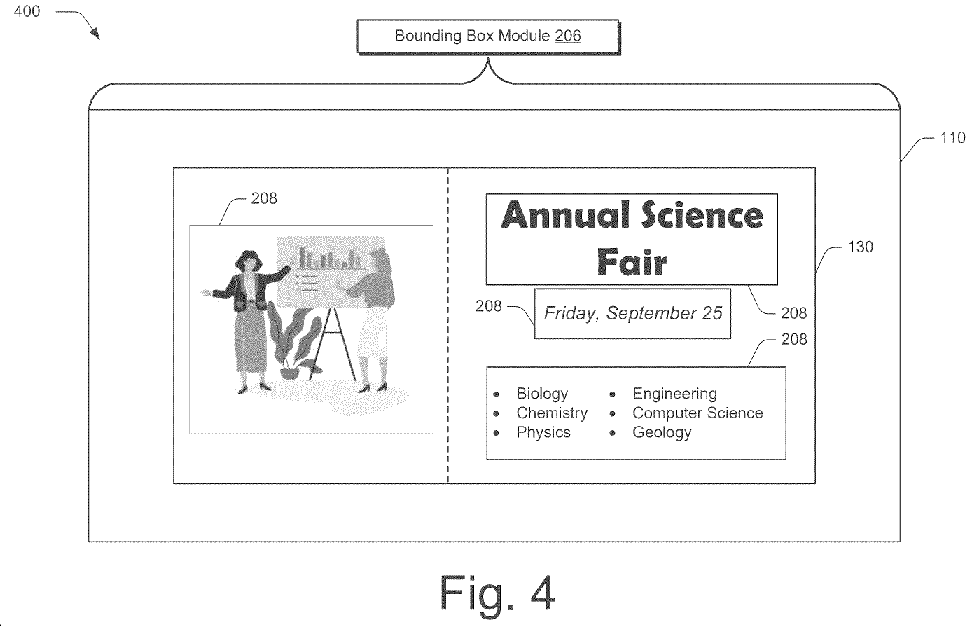

FIG. 4 depicts an example 400 of determining a layout and determining coordinates of bounding boxes. FIG. 4 is a continuation of the example described in FIG. 3. After receiving the input 120 including the visual elements 122, the indication of the document type 124, and the indication of the document size 126, the layout module 116 determines a layout 130 for the visual elements 122 and determines coordinates 210 of bounding boxes 208 for placement of the visual elements 122 in the layout 130.

As illustrated, the layout determination module 202 leverages a machine learning model 204 to determine a layout 130 based on the document type 124 and/or the document size 126. The layout 130 is a specific arrangement for the visual elements 122 or types of the visual elements 122 on the document 118 to be created. The machine learning model 204 is a multimodal large language model (MLLM) trained on training data including layouts corresponding to multiple inputs indicating document types and sizes.

For instance, the machine learning model 204 is provided with the visual elements 122, which is a sequence of images i₁, i₂, . . . iₙ, where n represents the component count, onto a canvas for the document type 124, which is a specific application scenario a (e.g., poster, social media post, book cover, etc.) with the document size 126, which includes defined dimensions w (width) and h (height). The canvas is either blank or has a predefined background.

For example, the document type 124 is a banner in this example, which involves a different layout than other document types. Additionally, the layout 130 in this example depends on the document size 126. For instance, the layout 130 for the 48″×4″ banner, which is horizontal, is different from a 20″×6″ banner, which is vertical. The machine learning model 204 therefore is trained to determine the layout 130 that includes an aesthetically-pleasing arrangement of the visual elements 122 on the document 118 based on the document type 124 and/or the document size 126. In this example, the machine learning model 204 determines the layout 130 that includes images at the left side of the banner and text at the right side of the banner.

The layout module 116 uses a bounding box module 206 to generate bounding boxes 208 indicating placement positions of the visual elements 122 in the layout 130 for the document 118. For instance, the bounding boxes 208 are rectangles or masks that designate specific positions for placement of the visual elements 122 on the document 118. The bounding boxes 208, for instance, have coordinates 210 indicating locations of corners of the bounding boxes 208 relative to dimensions of the document 118. One bounding box, in an example, corresponds to placement of a specific image from the visual elements 122, while a second bounding box corresponds to placement of a specific piece of text from the visual elements 122.

In this example, the machine learning model 204, in addition to receiving the visual elements 122, which include a sequence of design components i₁, i₂, . . . iₙ, is also provided a prompt 128 detailing instructions I specifying the document type 124, which is an application scenario a for the document 118, as well as a document size 126, which is a canvas size (w, h). The machine learning model 204 is tasked with predicting the layout of each component in a structured format. Cascading style sheets (CSS) is adopted to encapsulate layout properties including top, left, width, height, and another property layer that manages the stacking order of potentially overlapping elements. For instance, CSS is a style sheet language used to describe the appearance and formatting of a document written in HTML or XML and controls how elements on a webpage are displayed, including layouts, colors, fonts, spacing, and other attributes.

The machine learning model 204 is trained to perform three interrelated tasks, including coordinate predicting, layout recovery, and layout planning. Coordinate predicting involves predicting the coordinates 210 of a specific visual element of the visual elements 122 within a given design template or document type 124. Layout recovery involves predicting the coordinates 210 of the visual elements 122 in a template given a sequence of the visual elements 122. Layout planning involves arranging the visual elements 122 on a canvas by predicting the coordinates 210 corresponding to the visual elements 122. In this example, during preprocessing, visual elements 122 smaller than 5% of the canvas size or document 118 are excluded, and the templates are resized to result in the longest edge not exceeding a measurement of 128 pixels. While the three tasks contribute to model training, the layout planning task alone is evaluated during inference.

The machine learning model 204 in this example is trained using an mPLUG-Owl training paradigm, which is a multimodal framework integrating a large language model (LLM), a visual encoder, and a visual abstractor module. Specifically, mPLUG-Owl employs Llama-7b v1 as the LLM and CLIP ViT-L/14 as the visual encoder. The mPLUG-Owl uses LLMs in two stages: a first stage to extract visual knowledge from an image and then a second stage to understand the image. In the first stage, the visual knowledge module and abstractor module are trained with a frozen LLM module to align the image and text. In the second stage, language-only and multimodal supervised datasets are used to jointly fine-tune a low-rank adaptation (LoRA) module on the LLM and the abstractor module by freezing the visual knowledge module. The LLM is a type of machine learning model that is designed to understand, generate, and interact with human language inputs at a large scale. These machine learning models are trained on large amounts of text data using deep learning techniques (e.g., neural networks) to learn patterns, nuances, and the structure of language. In this example, mPLUG-Owl is trained on natural language text.

The visual abstractor module converts visual features from the CLIP ViT-L/ 14 into 64 tokens that match the dimensionality of text embeddings, allowing for the simultaneous processing of multiple visual inputs. Additionally, in this example the Llama v1 vocabulary is expanded with numerical tokens ranging from 0 to 128. The embeddings of the extended tokens are randomly initialized, and then tuned in further instruction tuning.

To maintain the integrity of original text designs for visual elements 122 including text, text content is converted into images. In some examples, the layout module 116 facilitates editing of the text after incorporation into the bounding boxes 208 of the layout 130.

In this example, the machine learning model 204 determines positions of bounding boxes 208 for placement of the visual elements 122, including the image of the science fair, the text for the title “Annual Science Fair,” the text for the subtitle “Friday, September 25,” and the bulleted list of the text including “Biology, Chemistry, Physics, Engineering, Computer Science, and Geology.” For instance, the bounding box for the image of the science fair is on the left side of the document 118, indicated by the layout 130, and the bounding boxes for the three instances of text are on the right side of the document 118, indicated by the layout 130.

The bounding boxes 208 in this example are defined by coordinates 210 that indicate positions of corners of the bounding boxes 208 relative to dimensions of the document 118. For instance, the bounding box corresponding to the image of the science fair has corner coordinates positioning it in a position measured from the lower-left corner of the document 118. The coordinates are measured in pixels or other units. In some examples, the coordinates 210 also indicate a layered order for the visual elements 122 for situations involving layered visual elements. For example, the bounding boxes 208 have coordinates of (left 0; top 0; width 81l height 98; layer 0), (left 5; top 4; width 70; height 117; layer 2), (left 15; top 68; width 50; height 20; layer 3), (left 2; top 1; width 80; height 98; layer 1).

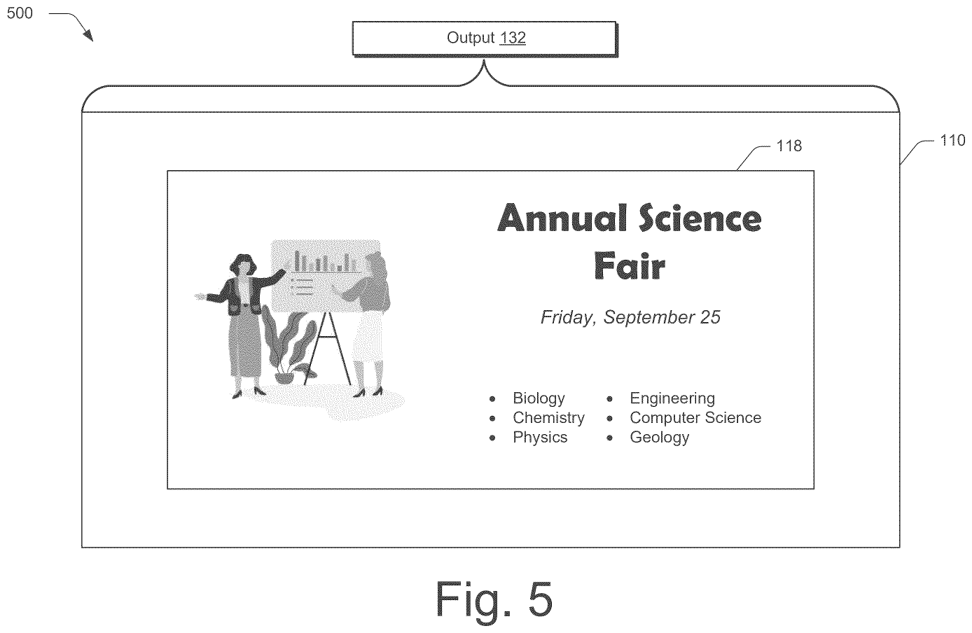

FIG. 5 depicts an example 500 of generating a document by incorporating visual elements into the bounding boxes. FIG. 5 is a continuation of the example described in FIG. 4. After positioning the visual elements 122 in the bounding boxes 208 of the layout 130 to generate the document 118, the layout module 116 generates an output 132 including the document 118 for display in a user interface 110. To do this, the layout module 116 positions the visual elements 122 in the corresponding bounding boxes 208 on the document 118. In some examples, this involves scaling, cropping, or adjusting the visual elements 122 to fit the bounding boxes 208. Additionally, in some examples the layout module 116 selects backgrounds or other visual properties for the document 118 based on the document type 124 using the machine learning model. For instance, the layout module 116 uses the machine learning model 204 to select a background color for the document 118 based on the document type 124.

In this example, the layout module 116 positions the image of the science fair in its corresponding bounding box, the text for the title “Annual Science Fair” in its corresponding bounding box, the text for the subtitle “Friday, September 25” in its corresponding bounding box, and the bulleted list of the text including “Biology, Chemistry, Physics, Engineering, Computer Science, and Geology” in its corresponding bounding box. The document 118 therefore includes the visual elements 122 arranged according to the layout 130 determined by the machine learning model 204.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-9.

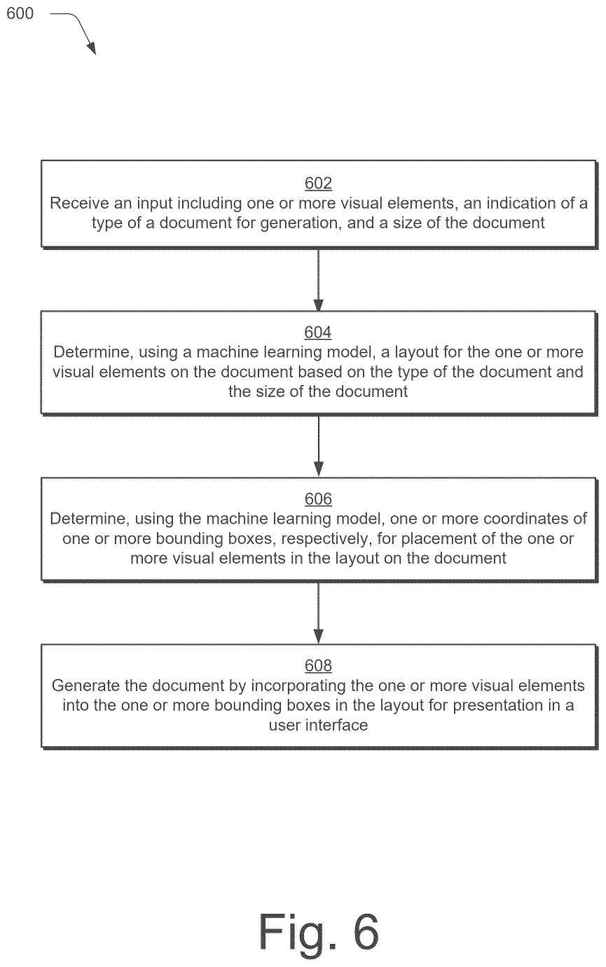

FIG. 6 depicts a procedure 600 in an example implementation of automatic layout generation. At block 602 an input 120 including one or more visual elements 122, an indication of a type of a document 118 for generation, and a size of the document 118 are received. For example, the input 120 includes a textual description of the document 118. In some examples, the indication of the type of the document 118 describes an intended use for the document 118.

At block 604, a layout 130 for the one or more visual elements 122 on the document 118 is determined, using a machine learning model 204, based on the type of the document 118 and the size of the document 118. In some examples, the machine learning model 204 is a multimodal large language model (MLLM) trained on multimodal document layouts and textual instructions for layout 130 generation.

At block 606, one or more coordinates 210 of one or more bounding boxes 208 for placement of the one or more visual elements 122 in the layout 130 on the document 118 are determined using the machine learning model 204. Some examples further comprise determining at least one color for application to the document based on the type of the document 118.

At block 608, the document 118 is generated by incorporating the one or more visual elements 122 into the one or more bounding boxes 208 in the layout 130 for presentation in a user interface 110. In some examples, each of the one or more visual elements 122 is placed within a corresponding bounding box of the one or more bounding boxes 208. Some examples further comprise scaling the one or more visual elements 122 to fit the one or more bounding boxes 208. In some examples, at least one of the one or more visual elements 122 includes text, and the text is converted to an image depicting the text. Additionally, some examples further comprise receiving an additional input indicating a change to the text and transforming the image depicting the text into altered text fitting a bounding box based on the additional input.

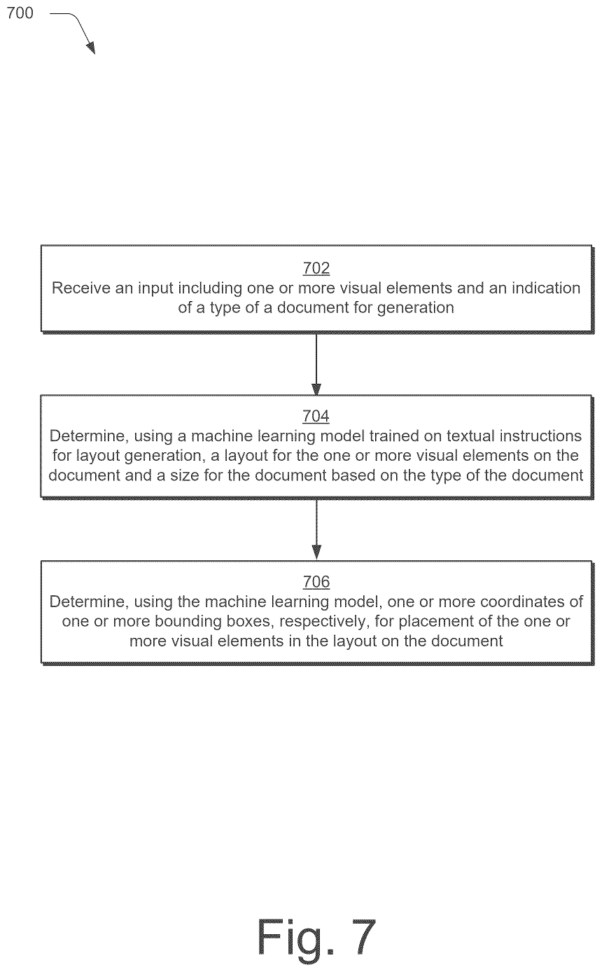

FIG. 7 depicts a procedure 700 in an additional example implementation of automatic layout generation. At block 702, an input 120 including one or more visual elements 122 and an indication of a type of a document 118 for generation is received. For example, the one or more visual elements 122 includes at least one of images or text. Some examples further comprise converting the text to an image depicting the text. In some examples, the indication of the type of the document 118 describes an intended use for the document 118.

At block 704, a layout 130 is determined for the one or more visual elements 122 on the document 118 and a size for the document 118 based on the type of the document 118, using a machine learning model 204 trained on textual instructions for layout 130 generation. For example, the machine learning model 204 is a multimodal large language model (MLLM).

At block 706, one or more coordinates 210 of the one or more bounding boxes 208 are determined, using the machine learning model 204, for placement of the one or more visual elements 122 in the layout 130 on the document 118. Some examples further comprise generating the document 118 by incorporating the one or more visual elements 122 into the one or more bounding boxes 208 in the layout 130 for presentation in a user interface 110. Additionally or alternatively, some examples further comprise scaling the one or more visual elements 122 to fit the one or more bounding boxes 208.

### Training Machine Learning Model

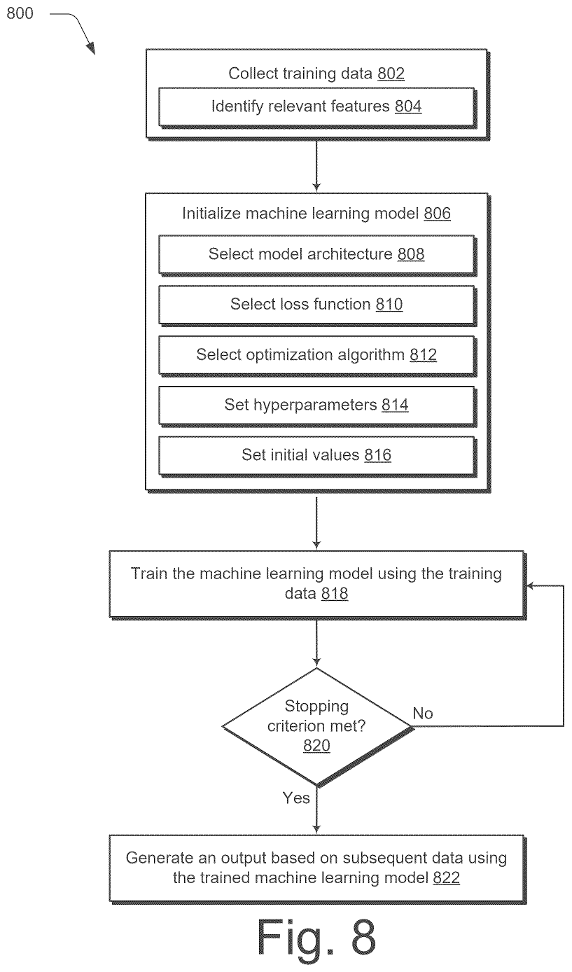

FIG. 8 is a flow diagram depicting an algorithm as a step-by-step procedure 800 in an example implementation of operations performable for training a machine learning model. The procedure 800 provides one or more examples of generating training data, use of the training data to train a machine learning model, and use of the trained machine learning model to perform a task.

To begin in this example, a machine learning system collects training data (block 802) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 804) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 806). Initialization of the machine learning model includes selecting a model architecture (block 808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 810). The loss function is utilized to measure a difference between an output of the machine learning model (i.e., predictions) and target values (e.g., as expressed by the training data) to be used to train the machine learning model. Additionally, an optimization algorithm is selected (812) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 814) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 818) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 820), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 800 continues training of the machine learning model using the training data (block 818) in this example.

If the stopping criterion is met (“yes” from decision block 820), the trained machine learning model is then utilized to generate an output based on subsequent data (block 822). The trained machine learning model, for instance, is trained to perform a task as described above and therefore once trained is configured to perform that task based on subsequent data received as an input and processed by the machine learning model.

### Example System and Device

FIG. 9 illustrates an example system generally at 900 that includes an example computing device 902 that is representative of one or more computing systems and/or devices that implement the various techniques described herein. This is illustrated through inclusion of the layout module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 1114 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized when computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving, by a processing device, an input including one or more visual elements, an indication of a type of a document for generation, and a size of the document;
determining, by the processing device using a machine learning model, a layout for the one or more visual elements on the document based on the type of the document and the size of the document;
determining, by the processing device using the machine learning model, one or more coordinates of one or more bounding boxes, respectively, for placement of the one or more visual elements in the layout on the document; and
generating, by the processing device, the document by incorporating the one or more visual elements into the one or more bounding boxes in the layout for presentation in a user interface.

2. The method of claim 1, wherein each of the one or more visual elements is placed within a corresponding bounding box of the one or more bounding boxes.

3. The method of claim 1, wherein the one or more visual elements include at least one of images or text.

4. The method of claim 3, further comprising converting the text to an image depicting the text.

5. The method of claim 4, further comprising receiving an additional input indicating a change to the text and transforming the image depicting the text into altered text fitting a bounding box based on the additional input.

6. The method of claim 1, wherein the input includes a textual description of the document.

7. The method of claim 1, wherein the machine learning model is a multimodal large language model (MLLM) trained on multimodal document layouts and textual instructions for layout generation.

8. The method of claim 1, wherein the indication of the type of the document describes an intended use for the document.

9. The method of claim 1, further comprising determining at least one color for application to the document based on the type of the document.

10. A system comprising:
a memory component; and
a processing device coupled to the memory component, the processing device to perform operations comprising:
receiving an input including one or more visual elements and an indication of a type of a document for generation;
determining, using a machine learning model trained on textual instructions for layout generation, a layout for the one or more visual elements on the document and a size for the document based on the type of the document; and
determining, using the machine learning model, one or more coordinates of one or more bounding boxes, respectively, for placement of the one or more visual elements in the layout on the document.

11. The system of claim 10, further comprising generating the document by incorporating the one or more visual elements into the one or more bounding boxes in the layout for presentation in a user interface.

12. The system of claim 11, further comprising scaling the one or more visual elements to fit the one or more bounding boxes.

13. The system of claim 10, wherein the one or more visual elements includes at least one of images or text.

14. The system of claim 13, further comprising converting the text to an image depicting the text.

15. The system of claim 10, wherein the machine learning model is a multimodal large language model (MLLM).

16. The system of claim 10, wherein the indication of the type of the document describes an intended use for the document.

17. A non-transitory computer-readable storage medium storing executable instructions, which when executed by a processing device, cause the processing device to perform operations comprising:
presenting a user interface configured to receive an input including one or more visual elements, an indication of a type of a document for generation, and a size for the document;
determining, using a machine learning model, a layout for the one or more visual elements on the document based on the type of the document and the size of the document;
determining, using the machine learning model, one or more coordinates of one or more bounding boxes, respectively, for placement of the one or more visual elements in the layout on the document; and
generating the document by incorporating the one or more visual elements into the one or more bounding boxes in the layout for presentation in the user interface.

18. The non-transitory computer-readable storage medium of claim 17, further comprising scaling the one or more visual elements to fit the one or more bounding boxes.

19. The non-transitory computer-readable storage medium of claim 17, wherein the machine learning model is a multimodal large language model (MLLM) trained on textual instructions for layout generation.

20. The non-transitory computer-readable storage medium of claim 17, wherein the indication of the type of the document describes an intended use for the document.
